(19) United States
(12) Patent Application Publication
(10) Pub. No.: US 2015/0097093 A1
(43) Pub. Date: Apr. 9, 2015

(54) Supporter Assembly and Related Display Device

(71) Applicant: Top Victory Investments Ltd., Kowloon (HK)

(72) Inventors: Yu-Hung Tsai, New Taipei City (TW); Ying Jen LIN, New Taipei City (TW); I-Ting CHIANG, New Taipei City (TW)

(73) Assignee: Top Victory Investments Ltd., Kowloon (HK)

(21) Appl. No.: 14/044,924

(22) Filed: Oct. 3, 2013

(51) Int. Cl. A47B 97/00; F16M 11/20; F16M 11/06

(52) U.S. Cl. CPC A47B 97/00; F16M 11/06; F16M 11/2007; A47B 2097/005; A47B 2097/008
USPC 248/124.2; 248/124.1

(57) ABSTRACT

The present invention provides a supporter assembly and a related display device. The display panel includes a first connecting portion. The supporter includes a first body and a second body. The first body includes a first inclined surface and a second connecting portion pivotably connected to the first connecting portion. The second body includes a second inclined surface adjacent to the first inclined surface. An end of the pivot portion is connected to the first inclined surface, and the other end is connected to the second inclined surface. The first inclined surface and the second inclined surface pivot to each other via the pivot portion, and the first body is able to pivot relative to the second body. Comparing to the prior art, the present invention can switch the operation modes of the supporter assembly and the related display device according to user's demand for the preferred touch operation.

### BACKGROUND OF THE INVENTION

1. Field of the Invention

The present invention relates to a supporter assembly and a related display device, and more particularly, to a rotary supporter assembly and a related display device.

2. Description of the Prior Art

With advanced touch technology, the touch panel is applied to the mobile device (such as the smart phone or the tablet computer) and the display device for the desktop computer extensively. The operation system of the desktop computer widespread provides touch application programs, and the desktop computer with the touch panel might be a future trend of the consumer electronic market. However, the desktop computer and the related display device are unstably set on the table, unlike convenience of the mobile device, because of unfavorable volume and weight. Generally, the display device of the desktop computer is disposed on a rear side of the table, which is far from the user, so that the user is inconvenient to contact the display device for the touch function.

The conventional supporter assembly applied to the display device of the desktop computer only has support function, and can not balance the parallel force on the display panel generated when the user clicks the display panel. Thus, the display device with the conventional supporter assembly is easily vibrated in the touch operation. The conventional display device, including the display panel and the related supporter assembly, does not provide an effective solution for overcoming the said drawbacks.

### SUMMARY OF THE INVENTION

The present invention aims to provide a supporter assembly and a related display device, the supporter assembly and the display device can switch operation modes according to user's demand for consumer-friendly touch operation.

According to the claimed invention, the supporter assembly includes a supporter and a pivot portion. The supporter includes a first body and a second body. A first inclined surface is formed on an end of the first body, a second inclined surface is formed on an end of the second body, and the first inclined surface corresponds to and is adjacent to the second inclined surface. An end of the pivot portion is connected to the first inclined surface, and the other end of the pivot portion is connected to the second inclined surface. The first inclined surface and the second inclined surface pivot to each other via the pivot portion, and the first body is able to pivot relative to the second body.

According to an embodiment of the claimed invention, the supporter includes a first operation mode and a second operation mode. The first body and the second body are coaxial when the supporter is at the first operation mode. An angle is formed between the first body and the second body when the supporter is at the second operation mode.

According to an embodiment of the claimed invention, the first inclined surface rotates relative to the second inclined surface substantially to 180 degrees in parallel when the supporter is switched from the first operation mode to the second operation mode.

According to an embodiment of the claimed invention, the first body is substantially perpendicular to the second body to form an L-shaped projection when the supporter is at the second operation mode, and the angle between the first body and the second body is 90 degrees substantially.

According to an embodiment of the claimed invention, the first inclined surface laps over the second inclined surface at the same level when the supporter is at the first operation mode or the second operation mode.

According to an embodiment of the claimed invention, an outer contour of the first body aligns with an outer contour of the second body to form an I-shaped projection when the supporter is at the first operation mode.

According to an embodiment of the claimed invention, a display device includes a display panel and a supporter assembly. The display panel includes a first connecting portion. Structure of the supporter assembly is the same as the above-mentioned embodiment. The end of the first body opposite to the first inclined surface further includes a second connecting portion pivotably connected to the first connecting portion.

The supporter assembly and the related display device of the present invention can switch the operation modes according to user's demand for the preferred touch operation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1. is an exploded diagram of a display device according to a preferred embodiment of the present invention.

FIG. 2 is a lateral view of the supporter at the first operation mode according to the preferred embodiment of the present invention.

FIG. 3 is a diagram of the supporter at the first operation mode according to the preferred embodiment of the present invention.

FIG. 4 is a lateral view of the supporter at the second operation mode according to the preferred embodiment of the present invention.

FIG. 5 is a diagram of the supporter at the second operation mode according to the preferred embodiment of the present invention.

### DETAILED DESCRIPTION

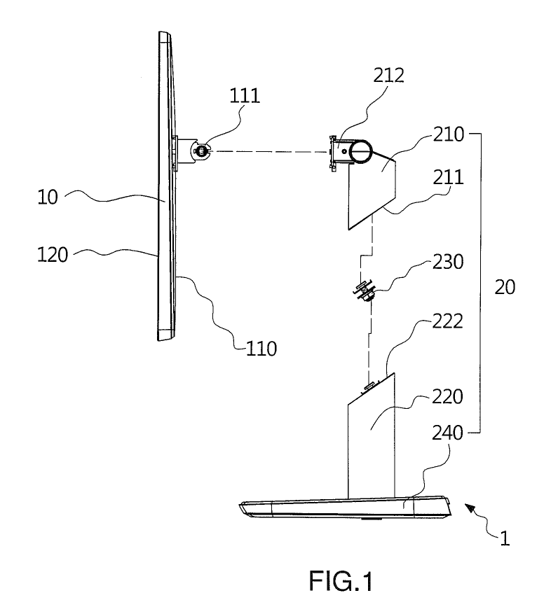

Please refer to FIG. 1. FIG. 1 is an exploded diagram of a display device in the present invention. The display device 1 includes a display panel 10 and a supporter assembly 20. The display panel 10 includes a back 110 and a bezel 120 opposite to each other. A first connecting portion 111, which conforms to VESA (Video Electronics Standards Association) standard, is disposed on the back 110 or is integrated with the back 110 monolithically. The supporter assembly 20 includes the supporter (not signed in figures) having a first body 210 and a second body 220. The supporter assembly 20 further includes a pivot portion 230 and a base 240. A first inclined surface 211 is formed on an end of the first body 210, and a second connecting portion 212 is disposed on the other end of the first body 210 opposite to the first inclined surface 211.

The first connecting portion 111 is pivotably connected to the second connecting portion 212. Pivot holes can be formed on the first connecting portion 111 and the second connecting portion 212, and the pivot holes axially align with each other. A shaft passes through the pivot holes on the first connecting portion 111 and the second connecting portion 212, so that the first connecting portion 111 can pivots to the second connecting portion 212, and an inclination angle of the display panel 10 relative to the level plane can be adjusted accordingly.

A second inclined surface 222 is formed on an end of the second body 220, and the base 240 is connected to the other end of the second body 220 opposite to the second inclined surface 222. The first inclined surface 211 corresponds to and is adjacent to the second inclined surface 222. An end of the pivot portion 230 is connected to the first inclined surface 211, and the other end of the pivot portion 230 is connected to the second inclined surface 222. The first inclined surface 211 pivots to the second inclined surface 222 via the pivot portion 230, and the first body 210 is able to pivot relative to the second body 220. The pivot portion 230 can includes a bar and two annular planks, the annular planks are connected to ends of the bar. One of the annular planks is rotatably disposed on the annular slot inside the first body 210, and the other annular plank is rotatably disposed on the annular slot inside the second body 220. Therefore, the first inclined surface 211 can rotate relative to the second inclined surface 222 in parallel adjacency.

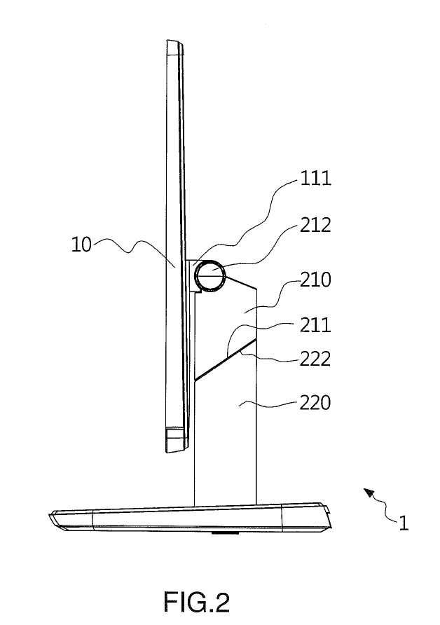

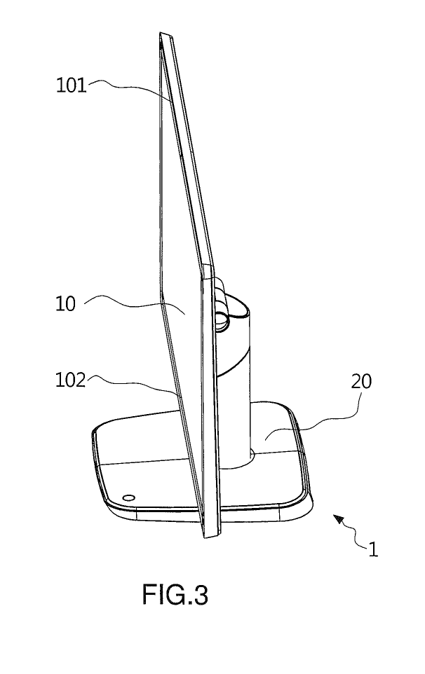

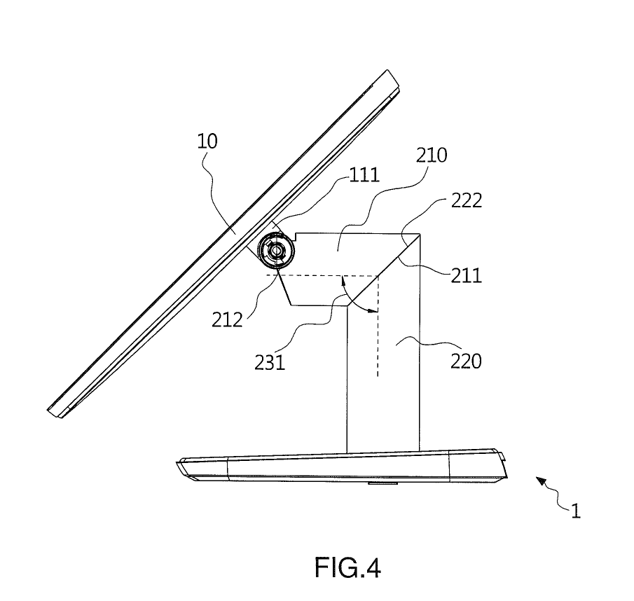

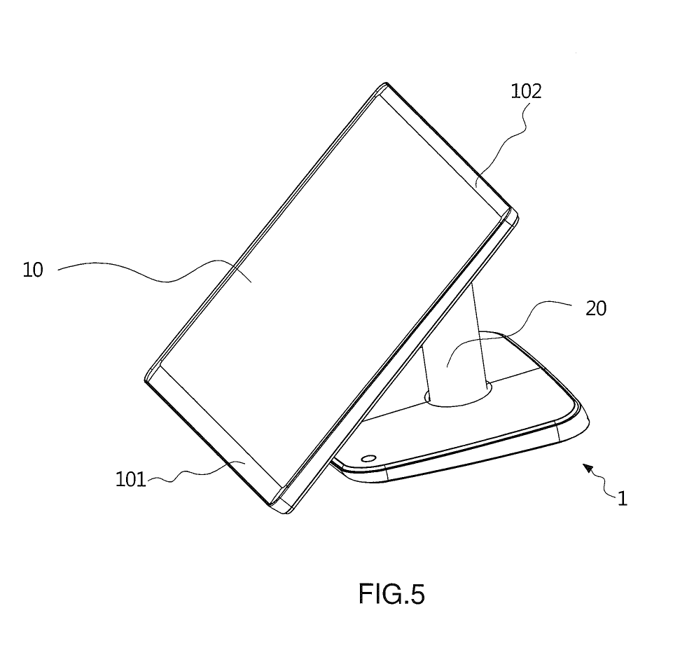

Please refer to FIG. 2 to FIG. 5. FIG. 2 is a lateral view of the supporter at the first operation mode in the present invention. FIG. 3 is a diagram of the supporter at the first operation mode in the present invention. FIG. 4 is a lateral view of the supporter at the second operation mode in the present invention. FIG. 5 is a diagram of the supporter at the second operation mode in the present invention. The supporter provides at least two modes, such as the said first operation mode and the said second operation mode, by the pivot mechanism including the pivot portion 230, the first body 210 and the second body 220. When the supporter is at the first operation mode, as shown in FIG. 2, the first body 210 and the second body 220 are coaxial, and the first inclined surface 211 laps over the second inclined surface 222 at the same level. An outer contour of the first body 210 aligns with an outer contour of the second body 220 to form an I-shaped projection. When the supporter is at the first operation mode, as the display panel 10 and the supporter assembly 20 shown in FIG. 3, a top end 101 of the display panel 10 is higher than the bottom end 102 of the display panel 10 for showing images on the display panel 10.

When the supporter is at the second operation mode, as shown in FIG. 4, an angle 231 is formed between axial directions of the first body 210 and the second body 220. The first inclined surface 211 aligns with the second inclined surface 222 at the same level to provide preferred aesthetic. As the supporter is switched from the first operation mode to the second operation mode, the first body 210 rotates relative to the second body 220, and the first inclined surface 211 rotates relative to the second inclined surface 222 substantially to 180 degrees in parallel. Besides, when the supporter is at the second operation mode, the first body 210 is substantially perpendicular to the second body 220 to form an L-shaped projection, and the angle 231 is 90 degrees substantially. In the meantime, as the display panel 10 and the supporter assembly 20 shown in FIG. 5, the display panel 10 rotates to 180 degrees, and the top end 101 is lower than the bottom end 102. The images of the display panel 120 can rotate automatically or manually accordingly to conform to state of the display panel 10. Further, the display panel 10 is close to the user when the supporter is at the second operation mode, the display panel 10 can be touched easily and conveniently for control operation. Besides, the top end 101 can contact against the level plane to stably hold the display panel 10. The display panel 10 is not vibrated when the user touches the display panel 10.

The supporter assembly and the related display device of the present invention can switch the operation modes according to user's demand, so as to provide preferable utilization. The display device close to the user has the stable holding function, and the display device has shockproof function for touch application.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A supporter assembly comprising:
a supporter, the supporter comprising a first body and a second body, a first inclined surface being formed on an end of the first body, a second inclined surface being formed on an end of the second body, the first inclined surface corresponding to and being adjacent to the second inclined surface; and
a pivot portion, an end of the pivot portion being connected to the first inclined surface, the other end of the pivot portion being connected to the second inclined surface, the first inclined surface and the second inclined surface pivoting to each other via the pivot portion, and the first body being able to pivot relative to the second body.

2. The supporter assembly of claim 1, wherein the supporter comprises a first operation mode and a second operation mode, the first body and the second body are coaxial when the supporter is at the first operation mode, an angle is formed between the first body and the second body when the supporter is at the second operation mode.

3. The supporter assembly of claim 2, wherein the first inclined surface rotates relative to the second inclined surface substantially to 180 degrees in parallel when the supporter is switched from the first operation mode to the second operation mode.

4. The supporter assembly of claim 3, wherein the first body is substantially perpendicular to the second body to form an L-shaped projection when the supporter is at the second operation mode, the angle between the first body and the second body is 90 degrees substantially.

5. The supporter assembly of claim 4, wherein the first inclined surface laps over the second inclined surface at the same level when the supporter is at the first operation mode or the second operation mode.

6. The supporter assembly of claim 5, wherein an outer contour of the first body aligns with an outer contour of the second body to form an I-shaped projection when the supporter is at the first operation mode.

7. A display device comprising:
a display panel, the display panel comprising a first connecting portion; and
a supporter assembly, the supporter assembly comprising:
a supporter, the supporter comprising a first body and a second body, a first inclined surface being formed on an end of the first body, a second inclined surface being formed on an end of the second body, the first inclined surface corresponding to and being adjacent to the second inclined surface, wherein the end of the first body opposite to the first inclined surface comprises a second connecting portion pivotably connected to the first connecting portion; and
a pivot portion, an end of the pivot portion being connected to the first inclined surface, the other end of the pivot portion being connected to the second inclined surface, the first inclined surface and the second inclined surface pivoting to each other via the pivot portion, and the first body being able to pivot relative to the second body.

8. The display device of claim 7, wherein the supporter comprises a first operation mode and a second operation mode, the first body and the second body are coaxial when the supporter is at the first operation mode, an angle is formed between the first body and the second body when the supporter is at the second operation mode.

9. The display device of claim 8, wherein the first inclined surface rotates relative to the second inclined surface substantially to 180 degrees in parallel when the supporter is switched from the first operation mode to the second operation mode, the first inclined surface laps over the second inclined surface at the same level when the supporter is at the first operation mode or the second operation mode.

10. The display device of claim 9, wherein an outer contour of the first body aligns with an outer contour of the second body to form an I-shaped projection when the supporter is at the first operation mode, the first body is substantially perpendicular to the second body to form an L-shaped projection when the supporter is at the second operation mode, the angle between the first body and the second body is 90 degrees substantially.
